(19) United States
(12) Patent Application Publication
(10) Pub. No.: US 2022/0268399 A1
(43) Pub. Date: Aug. 25, 2022

(54) QUICK CONNECT BAND CLAMP SYSTEM

(71) Applicant: Vincent S. WARNER, Cedar Hills, UT (US)

(72) Inventor: Vincent S. WARNER, Cedar Hills, UT (US)

(21) Appl. No.: 17/585,245

(22) Filed: Jan. 26, 2022

Related U.S. Application Data
(60) Provisional application No. 63/141,699, filed on Jan. 26, 2021.

(51) Int. Cl. F16M 11/20; F16M 11/22

(52) U.S. Cl. CPC F16M 11/2014; F16M 11/22; F16M 2200/022

(57) ABSTRACT

A ring clamp system for connecting tripod-type supports and which secures equipment to a support while allowing 360° rotation of said equipment without the means of a threaded bolt connection. The ring features a tightening means and two annular edges that interface with V-shaped grooves on the support structure and with the attached equipment thereby holding the equipment and support together while selectively allowing rotation of the equipment thereon. Adapters may be provided so that the invention may be practiced utilizing equipment and supports which have not been manufactured specifically for use with the system.

### CROSS-REFERENCES TO RELATED APPLICATIONS

This application claims priority as a non-provisional perfection of prior filed U.S. Application 63/141,699, filed Jan. 26, 2021, and incorporates the same by reference in its entirety by reference herein.

### FIELD OF THE INVENTION

The present invention relates to the field of supports and more particularly relates to a quick connection method for attaching distinct types of equipment to a tripod head top disk or to a leveling base bowl disk as it relates to photography video equipment, mechanical brackets, and industrial equipment such as survey transits, 3d lasers scanners and related systems.

### BACKGROUND OF THE INVENTION

For decades, the common method to attach photographic tripod heads and other equipment is to utilize an industry standard ⅜″-16 or ¼″-20 male thread stud interface screw at the top of the tripod center tube top disk or bowl top leveling disk. The mating component, with a similarly equipped female mating thread feature, is then twisted onto the male stud creating a fixed non-movable connection. Unfortunately, users are often confronted with the amount of time, tools, and awkwardness necessary to attach and detach these components using the comparatively slow rotating threaded connection method. It is also worth noting that the nature of the design is not conducive to a secure connection to prevent the items from coming “unscrewed” when a rotating force is applied in the counterclockwise direction. Such forces tend to tend to unscrew the device from the tripod top disk or bowl disk if the connection is not secure enough to prevent it from doing so. To counter these undesired behaviors, additional screw systems are often employed in the tripod top disk, head, or bowl disk to create a more secure and positive interface connection. This then creates even more obstacles from being able to quickly connect and disconnect these components from the tripod or disk.

The present invention creates a system that provides an improved method for attaching objects such as tripod-heads, lasers, projectors, etc. to a traditional tripod top disk and to a tripod leveling base bowl disk system. This invention creates a quick, secure, and tool-less method for attaching and detaching any number of components to a tripod with the added benefit of providing the optional 360-degree rotation functionality between these components which is not possible with the thread connection method.

### SUMMARY OF THE INVENTION

In view of the foregoing disadvantages inherent in the traditional ⅜-16 threaded tripod to-head connection method, this invention adds many improvements and benefits not possible with other methods. In addition to tripods and integrated mating components, this invention also allows for the retrofitting of existing tripod-head components and other equipment to provide the same functionality and benefits as an integrated design.

This invention is a complete departure from the prevailing method of using threaded connections for attaching tripod heads and other industrial devices. Rather, it employs a friction positive band clamp system for a quick and secure connection that also adds 360° rotation functionality which is not possible with other designs.

The more notable features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in numerous ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions as far as they do not depart from the spirit and scope of the present invention.

### BRIEF DESCRIPTION OF THE DRAWINGS

FIG. 1 is a side elevation of a prior art pan head.

FIG. 2 is a sectional view of the pan head of FIG. 1, taken along line II-II.

FIG. 3 is an exploded view of the pan head of FIG. 1.

FIG. 4 is a side elevation of one embodiment of the invention.

FIG. 5 is a side elevation of a second embodiment of the invention.

FIG. 6 is a sectional view of the embodiment shown in FIG. 4 taken along line VI-VI.

FIG. 7 is an exploded view of the embodiment shown in FIG. 4.

FIG. 8 is a sectional view of the embodiment shown in FIG. 5, taken along line VIII-VIII.

FIG. 9 is an exploded view of the embodiment shown in FIG. 5.

FIG. 10 is an exploded view of the embodiment shown in FIG. 5, utilizing a projector instead of a ball head.

### DETAILED DESCRIPTION OF THE PREFERRED EMBODIMENT

With reference now to the drawings, a preferred embodiment of the clamp system is herein described. It should be noted that the articles “a,” “an,” and “the,” as used in this specification, include plural referents unless the content clearly dictates otherwise.

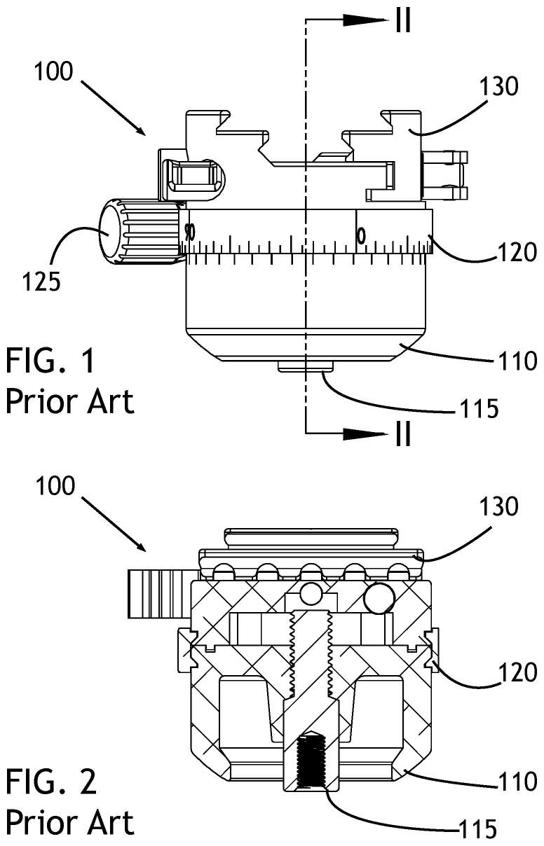

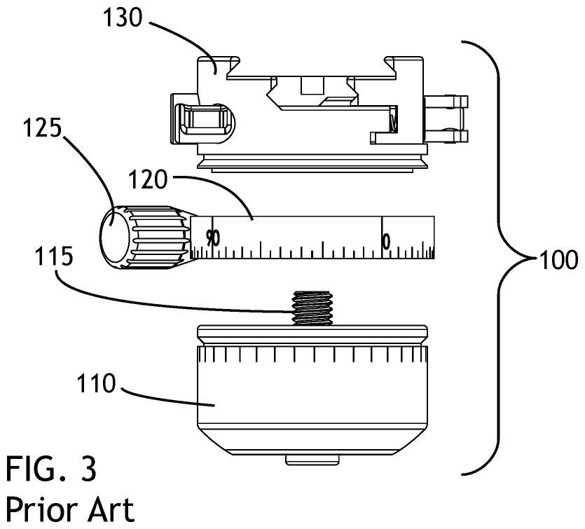

With reference to FIGS. 1-3, a prior art ball head 100 features a base 110 supporting a clamp 130. Base 110 interfaces with a tripod or some other support through bolt 115. A band 120 circumscribes the top edge of the base 110 and the bottom edge of the clamp 130. Both components feature a V-shaped groove circumscribing the bottom edge of clamp 130 and the top edge of base 110. Band 120 has two annular inner edges, one at its top and one at its bottom, which then interface with the V-shaped grooves. A tightening means, such as bolt 125, is used to tighten or loosen band 120 and allow or arrest rotation of the clamp 130. If sufficiently loosened, the band 120 will allow the removal of clamp 130 from the system. Otherwise, the interface of the annular inner edges and the V-shaped grooves will secure the clamp 130 to the base 110.

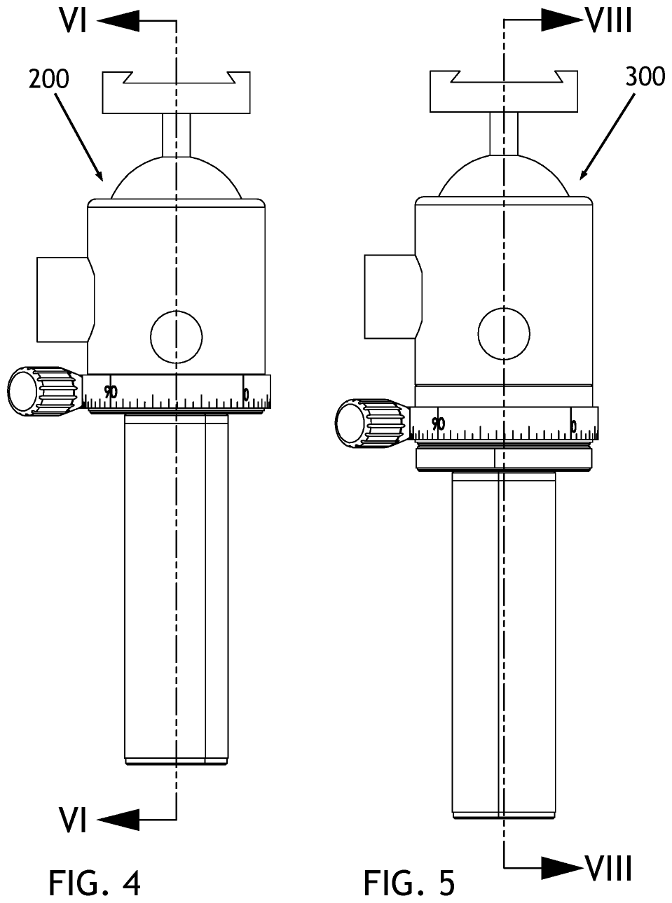

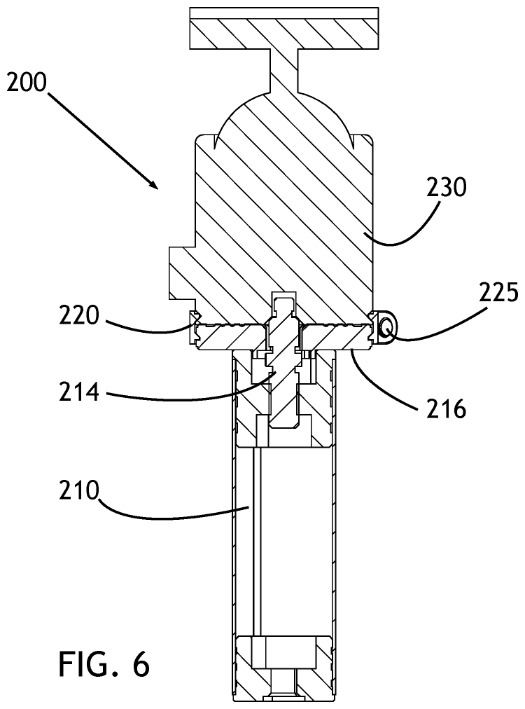

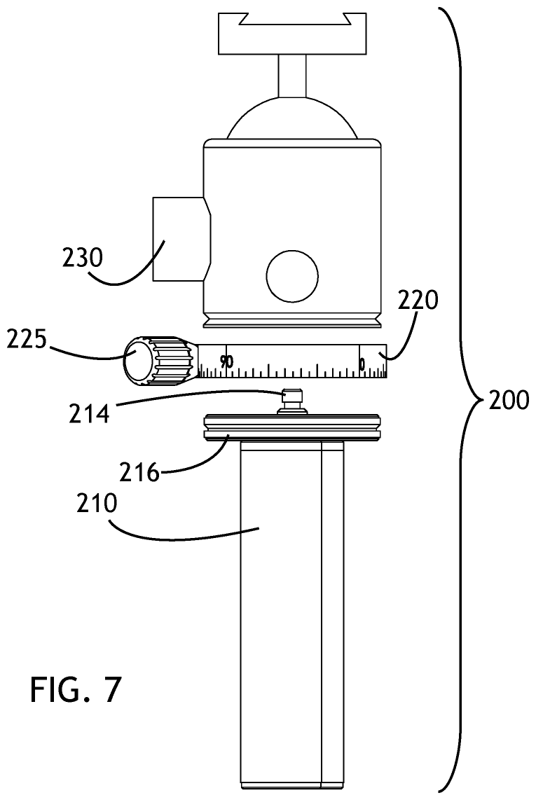

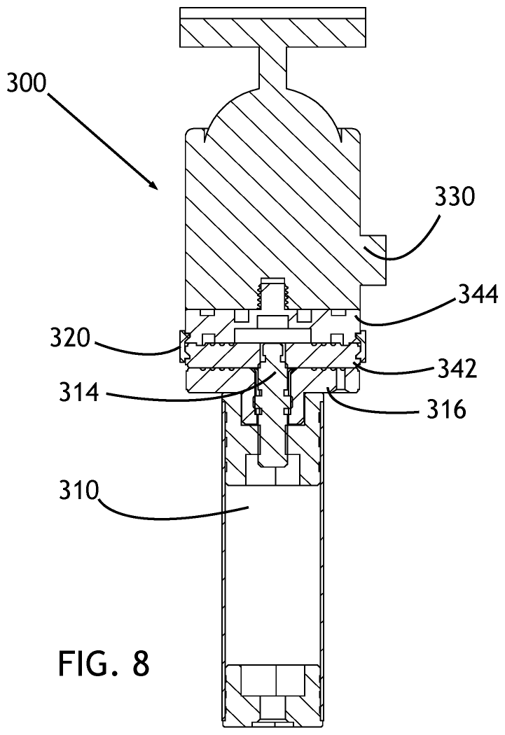

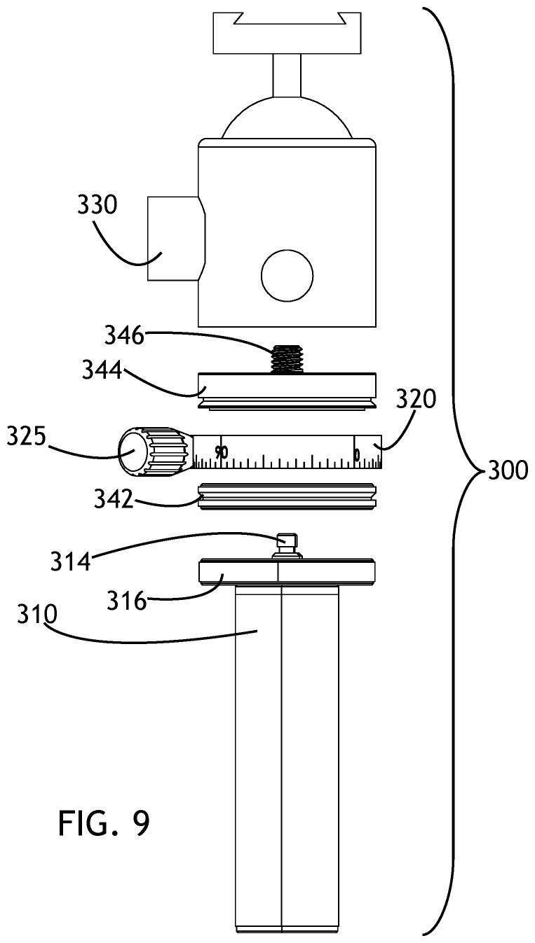

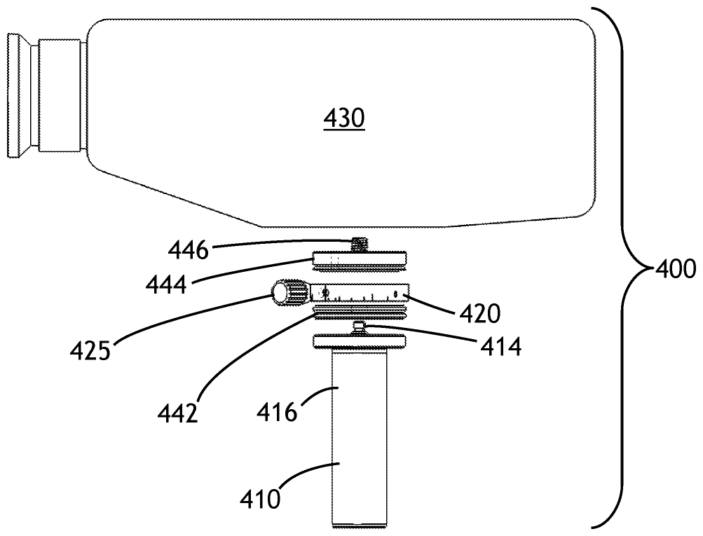

This connection system shown in the prior art may be improved for utilization in other structures which may adapt current systems to the improved band clamp system or may utilize other components inherently adapted to the system. Two examples are shown in FIGS. 4 (200) and 5 (300). In FIG. 4, a ball head and an upper tripod tube are adapted to work with the band system, as further shown in FIGS. 6 and 7. In FIG. 5 a prior art ball head and prior art tripod tube are fitted with spacing washer adapters to work with the band system, as further shown in FIGS. 8 and 9. For system 200, shown in FIGS. 4 and 6-7, a tripod tube 210 has a platform 216 on which the ball head 230 rests. A stud screw 214 resides within the tripod tube 210 and extends out from the platform 216. This stud screw may be of any shape or size contemplated in the prior art or in the future. Currently stud screws are removable from tripod components and feature two different sized screws on either end. The standard screw sizes are ¼×20 (¼-inch diameter with 20 threads per inch) and ⅜×16 (⅜-inch diameter with 16 threads per inch). The ball head 230 features a hole in its bottom which may be sized to receive either of the presented stud screw ends, but for convenience may be made to receive, without engaging, the ¼×20 size. The bottom of the ball head 230 and platform 216 present V-shaped grooves for the ring 220 to circumscribe. Tightening means 225 then secures the ring 220, platform 216, and ball head 230 together. Loosening the tightening means 225 allows the ball head a full 360° rotation about the tripod tube 210.

In system 300, shown in FIGS. 5 and 8-9, a prior art ball head 330 and prior art tube 310 are adapted for a ring clamp 320. This is done by providing two adapter spacing washers 342, 344. The bottom spacing washer 342 resides on top of the platform 316 and covers stud screw 314 so that it only interfaces with bottom spacing washer 342. The interface between stud screw 314 and bottom spacing washer 342 may be such that they are securely threaded together and the interface between them may utilize either end of stud screw 314. Top adapter spacing washer 344 interfaces with the ball head 330. Top adapter spacing washer 344 may utilize its own stud screw which may be made to whatever specification is required, such as the depicted ⅜×16 interface. Whichever interfaces are used, top adapter spacing washer 344 is securely fastened to ball head 330. Both adapter spacing washers feature the necessary V-shaped annular grooves that allow interface with ring 320. As with the previous embodiment, tightening means 325 is utilized to selectively tighten or loosen the ring 320. In this manner current photographic and support equipment may be adapted to utilize the ring clamp system of this invention.

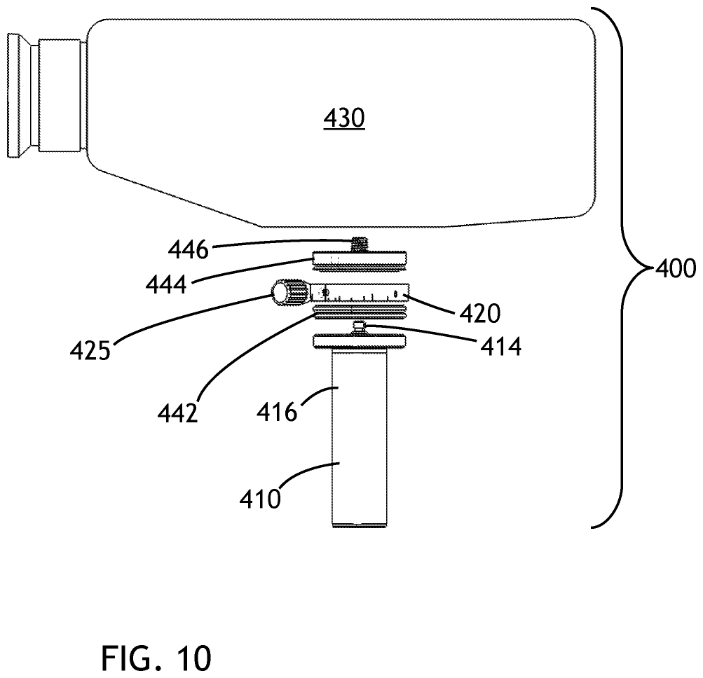

Different equipment may be mounted upon either embodiment of the connection system, as is shown in FIG. 10 where the system shown in FIG. 5 is modified 400 with a video projector 430. In this system, and prior art tube 410 and projector 430 are adapted for a ring clamp 420. This is done by providing two adapter discs 442, 444. The bottom adapter spacing washer 442 resides on top of the platform 416 and covers stud screw 414 so that it only interfaces with bottom spacing washer 442. The interface between stud screw 414 and bottom spacing washer 442 may be such that they are securely threaded together and the interface between them may utilize either end of stud screw 414. Top adapter spacing washer 444 interfaces with the projector 430. Top adapter spacing washer 444 may utilize its own stud screw which may be made to whatever specification is required, such as the depicted ⅜×16 interface. Whichever interfaces used, top adapter spacing washer 444 is securely fastened to ball head 430. Both adapter discs feature the necessary V-shaped grooves that allow interface with ring 420. As with the previous embodiment, tightening means 425 is utilized to selectively tighten or loosen the ring 420.

Although the present invention has been described with reference to preferred embodiments, numerous modifications and variations can be made and still the result will come within the scope of the invention. No limitation with respect to the specific embodiments disclosed herein is intended or should be inferred. It should be noted that the depicted embodiments utilize a ball head support for various forms of equipment. The invention is adaptable to any type of support used in the fields described in this specification, not just tripods, and any form of equipment which may be supported on such devices. Likewise, the tightening means is depicted as a simple knob-headed bolt which selectively increases or decreases the diameter of the ring. Other means of selectively tightening the ring may be utilized, such as a throw lever.

What is claimed is:

1. A quick connect band clamp system for optionally connecting and separating equipment to a mounting structure, the system comprising:
a circular band having a circumference, a height, and a width and two annular lips, one upper lip and one lower lip, along an inner circumference of the band, opposed to each other across the height of the circular band;
a lower spacing washer connectable to the mounting structure, having a lower circumference and further comprising an annular groove about said lower circumference, and
a means to adjust the circumference of the circular band;
the circular band fitting about the lower spacing washer such that the lower lip of the circular band interfaces with the annular groove of the lower spacing washer and the means to adjust the circumference of the circular band optionally restricts and expands the size of the circular band;
wherein the system allows 360° rotation of the equipment about the mounting structure and the means to adjust the circumference of the circular band may be used to arrest said rotation.

2. The quick connect band clamp system of claim 1, further comprising an upper spacing washer attachable to the equipment, said upper spacing washer having an upper circumference and further comprising an annular groove about said upper circumference, the upper lip of the circular band interfacing with said annular groove of the upper spacing washer.
